(19) United States
(12) Patent Application Publication
(10) Pub. No.: US 2023/0167587 A1
(43) Pub. Date: Jun. 1, 2023

(54) HOLLOW CARBON FIBER TUBE

(71) Applicant: Industrial Technology Research Institute, Hsinchu (TW)

(72) Inventors: Shir-Joe Liou, Taichung City (TW); Ming-Jun Li, New Taipei City (TW)

(73) Assignee: Industrial Technology Research Institute, Hsinchu (TW)

(21) Appl. No.: 17/567,888

(22) Filed: Jan. 4, 2022

(30) Foreign Application Priority Data
Nov. 29, 2021 (TW) 110144443

(51) Int. Cl. D01F 9/12; C08L 101/12; C08K 3/04; D01D 5/24; D01F 8/04

(52) U.S. Cl. CPC D01F 9/12; C08L 101/12; C08K 3/042; D01D 5/24; D01F 8/04; D10B 2101/12

(57) ABSTRACT

Provided is a hollow carbon fiber tube formed by winding a composite material body. The composite material body includes a plurality of carbon fiber prepreg layers and at least one graphene-containing resin layer. Each of the at least one graphene-containing resin layer is disposed between two adjacent carbon fiber prepreg layers. The total thickness of the at least one graphene-containing resin layer is 1/15 to ⅓ of the thickness of the composite material body.

### CROSS-REFERENCE TO RELATED APPLICATION

This application claims the priority benefit of Taiwan application serial no. 110144443, filed on Nov. 29, 2021. The entirety of the above-mentioned patent application is hereby incorporated by reference herein and made a part of this specification.

### TECHNICAL FIELD

The present disclosure relates to a hollow carbon fiber tube with torsional vibration suppression property.

### BACKGROUND

Since polymer fiber composite products have the characteristics of light weight, high mechanical strength and high design freedom, it is an inevitable development trend to combine various functional properties and uses in the structure of polymer fiber composite material.

The polymer fiber composite products are developing towards lightweight and small size, so the structural design focuses on high mechanical strength. However, material with higher mechanical strength are often accompanied by increased brittleness, causing the material to break due to increased brittleness after being subjected to torsion. Therefore, improving the damping characteristic of material to increase the torsional vibration suppression effect has become an important issue.

### SUMMARY

An embodiment of the present disclosure provides a hollow carbon fiber tube formed by winding a composite material body. The composite material body includes a plurality of carbon fiber prepreg layers and at least one graphene-containing resin layer. Each of the at least one graphene-containing resin layer is disposed between two adjacent carbon fiber prepreg layers. The total thickness of the at least one graphene-containing resin layer is 1/15 to ⅓ of the thickness of the composite material body.

To make the aforementioned more comprehensible, several embodiments accompanied with drawings are described in detail as follows.

### BRIEF DESCRIPTION OF THE DRAWINGS

FIG. 1 is a three-dimensional schematic diagram of a hollow carbon fiber tube of an embodiment of the present disclosure.

FIG. 2 is a schematic side view of the hollow carbon fiber tube of FIG. 1 from the end.

FIGS. 3 to 8 are schematic cross-sectional views of hollow carbon fiber tubes of different embodiments of the present disclosure.

FIG. 9 is a schematic diagram illustrating the graphene location index of the hollow carbon fiber tube.

### DESCRIPTION OF THE EMBODIMENTS

The embodiments are described in detail below with reference to the accompanying drawings, but the embodiments are not intended to limit the scope of the present disclosure. In addition, the drawings are for illustrative purposes only and are not drawn to the original dimensions. For the purpose of easy understanding, the same elements in the following description will be denoted by the same reference numerals.

The terms mentioned in the text, such as “comprising”, “comprising” and “having” are all open-ended terms, i.e., meaning “comprising but not limited to”.

When using terms such as “first” and “second” to describe a device, it is only used to distinguish these devices from each other, and does not limit the order or importance of these devices. Therefore, in some cases, the first device can also be called the second device, and the second device can also be called the first device, and this does not deviate from the scope of the present disclosure.

In addition, in the text, the range represented by “a value to another value” is a summary expression way to avoid listing all the values in the range one by one in the specification. Therefore, the record of a specific numerical range covers any numerical value within the numerical range, as well as a smaller numerical range defined by any numerical value within the numerical range.

The hollow carbon fiber tube of the embodiment of the present disclosure is formed by winding a composite material body, and the composite material body includes a plurality of carbon fiber prepreg layers and at least one graphene-containing resin layer disposed between two adjacent carbon fiber prepreg layers. When the hollow carbon fiber tube of the embodiment of the present disclosure is twisted under a force, slight slip may be occurred between the walls of graphene in the graphene-containing resin layer, and the accumulated slight slip may quickly amplify the damping characteristic of the composite material body, thereby achieving the effect of suppressing torsional vibration. As a result, the hollow carbon fiber tube of the embodiment of the present disclosure may has a better damping ratio (δ). Therefore, the hollow carbon fiber tube of the embodiment of the present disclosure is suitable as a component of a conveying apparatus, such as a robotic arm, to extend the lifetime of the conveying apparatus. The hollow carbon fiber tube of the embodiment of the present disclosure will be described in detail below.

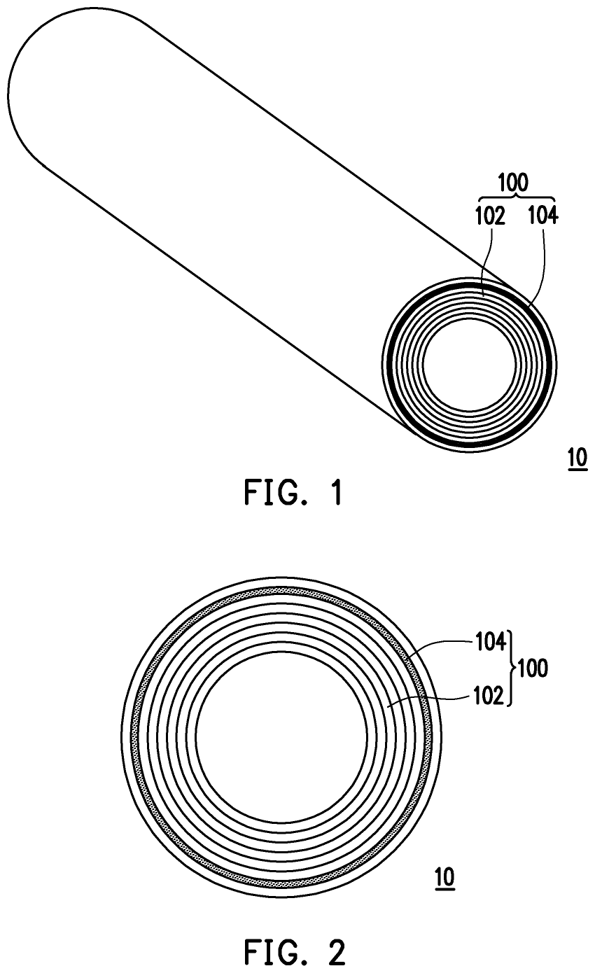

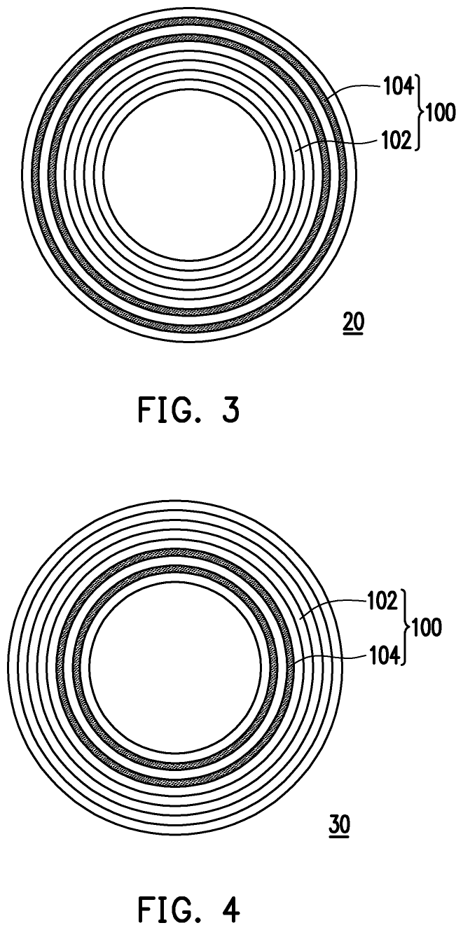

FIG. 1 is a three-dimensional schematic diagram of a hollow carbon fiber tube of an embodiment of the present disclosure. FIG. 2 is a schematic side view of the hollow carbon fiber tube of FIG. 1 from the end. Referring to FIGS. 1 and 2, the hollow carbon fiber tube 10 of an embodiment of the present disclosure is formed by winding a composite material body 100. In the present embodiment, the hollow carbon fiber tube 10 is a cylindrical tube. In other embodiments, the hollow carbon fiber tube 10 may be an oval tube, a rectangular tube, a triangular tube or other polygonal tubes.

In the present embodiment, the composite material body 100 includes a plurality of carbon fiber prepreg layers 102 and a graphene-containing resin layer 104 in a thickness direction of the composite material body 100. The graphene-containing resin layer 104 is disposed between two adjacent carbon fiber prepreg layers 102. In the present embodiment, the composite material body 100 includes seven carbon fiber prepreg layers 102 stacked, but the present disclosure is not limited thereto. In addition, the graphene-containing resin layer 104 is disposed between two outermost carbon fiber prepreg layers 102, but the present disclosure is not limited thereto.

The carbon fiber prepreg layer 102 includes a resin material and a carbon fiber layer impregnated with the resin material. In the present embodiment, the resin material may be a thermoplastic material or a thermosetting material. The thermoplastic material may be polycarbonate, nylon, polypropylene, polyphenylene sulfide or polyether ether ketone. The thermosetting material may be epoxy resin. The detailed structure of the carbon fiber prepreg layer 102 is well known to those skilled in the art, and the resin material and the carbon fiber layer are not shown in detail in FIGS. 1 and 2 to make the drawing clear. The thickness of the carbon fiber prepreg layer 102 is, for example, 50 μm to 200 μm, and the thickness of the carbon fiber prepreg layer 102 may be the same or different from each other. The carbon fiber prepreg layer 102 may be formed by manual laminating method, spraying laminating method, continuous laminating method, vacuum bag method, winding method, extrusion method, injection method, injection molding method, sheet molding method (SMC), block shape molding method (BMC), prepreg molding method or autoclave molding method.

The graphene-containing resin layer 104 includes a resin material and graphene contained in the resin material. In the present embodiment, the resin material may be the above-mentioned thermoplastic material or thermosetting material. In addition, the resin material of the graphene-containing resin layer 104 may be the same as or different from the resin material of the carbon fiber prepreg layer 102. Graphene contained in the resin material may have a specific surface area of 30 m²/g to 500 m²/g. In this range, the slight slip phenomenon between the layer walls of the graphene-containing resin layer 104 may effectively amplify the damping characteristic of the composite material body 100. The thickness of the graphene-containing resin layer 104 is, for example, 5 μm to 200 μm. In the graphene-containing resin layer 104, based on the total weight of the graphene-containing resin layer 104, the content of graphene is, for example, 0.5 wt % to 5 wt % or 1 wt % to 3 wt %. When the content of graphene is less than 0.5 wt %, the graphene-containing resin layer 104 may not effectively improve the damping characteristic of the composite material body 100. When the content of graphene is greater than 5 wt %, the damping characteristic of the composite material body 100 may not be further improved, and the mechanical strength of the composite material body 100 may be reduced. In addition, the surface of graphene may be modified to have reactive functional groups to improve the dispersibility of graphene in the resin material. The reactive functional group may be an amine group, a carboxyl group, a hydroxyl group, an acyl chloride group or a combination thereof. The method of modifying the surface of graphene may be referred to the method disclosed in J. Mater. Chem., 2011, 21, 7337-7342.

In addition, in the composite material body, the total thickness of the graphene-containing resin layer is 1/15 to ⅓ of the thickness of the composite material body. In the present embodiment, the composite material body 100 includes only one graphene-containing resin layer 104, so the thickness of the graphene-containing resin layer 104 is 1/15 to ⅓ of the thickness of the composite material body 100. When the total thickness of the graphene-containing resin layer is less than 1/15 of the thickness of the composite material body 100, the graphene-containing resin layer may not effectively improve the damping characteristic of the composite material body 100. When the total thickness of the graphene-containing resin layer is greater than ⅓ of the thickness of the composite material body 100, the damping characteristic of the composite material body 100 may not be further improved, and the mechanical strength of the composite material body 100 may be reduced.

In the present embodiment, the graphene-containing resin layer 104 is disposed between the two outermost carbon fiber prepreg layers 102. That is, the graphene-containing resin layer 104 is disposed adjacent to the outer surface of the hollow carbon fiber tube 10. In this case, the hollow carbon fiber tube 10 may be regarded as having an outer-layer graphene design. Conversely, when the graphene-containing resin layer 104 is disposed away from the outer surface of the hollow carbon fiber tube 10, the hollow carbon fiber tube 10 may be regarded as having an inner-layer graphene design. In addition, the graphene-containing resin layer 104 may also be disposed in the center portion of the composite material body 100.

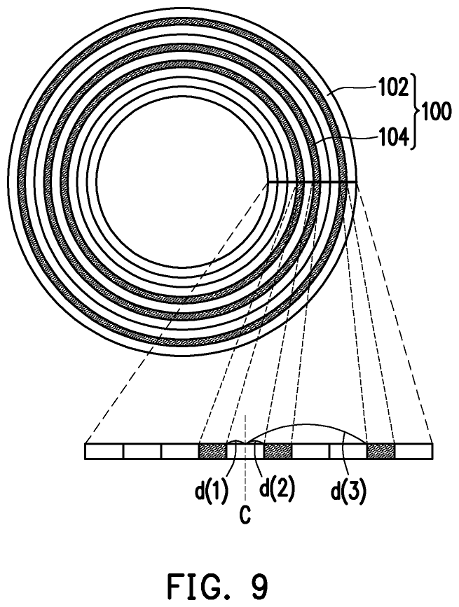

In an embodiment, the outer-layer graphene design and the inner-layer graphene design may be defined according to the following method. In the hollow carbon fiber tube of the embodiment of the present disclosure, the center is defined as center point C in the thickness direction of the composite material body, as shown in FIG. 9. The number of graphene-containing resin layers in the composite material body is n, and the distance from the i-th graphene-containing resin layer to center point C is d(i). The distance from the graphene-containing resin layer adjacent to the outer surface of the hollow carbon fiber tube to the center point C is positive, and the distance from the graphene-containing resin layer adjacent to the inner surface of the hollow carbon fiber tube to the center point C is negative. In addition, the graphene location index L of the hollow carbon fiber tube is calculated according to Formula (1).

$$L = \frac{d ( 1 ) + d ( 2 ) + … + d ( n )}{n} \qquad Formula ( 1 )$$

Take the structure in FIG. 9 as an example, L=[d(1)+d(2)+d(3)]/3.

When L is greater than 0, the hollow carbon fiber tube 10 may be regarded as having an outer-layer graphene design. When L is less than 0, the hollow carbon fiber tube 10 may be regarded as having an inner-layer graphene design. In the following, the method is used to define the design type of the hollow carbon fiber tube, but the present embodiment disclosure is not limited thereto.

In the hollow carbon fiber tube 10, only one graphene-containing resin layer 104 is disposed, and the graphene-containing resin layer 104 is located between the two outermost carbon fiber prepreg layers 102. Therefore, n is 1 and d(1) of the graphene-containing resin layer 104 is greater than 0. As a result, the graphene location index L of the hollow carbon fiber tube 10 is greater than 0, which may be regarded as having an outer-layer graphene design.

In the above embodiment, only one graphene-containing resin layer is disposed in the hollow carbon fiber tube, but the present disclosure is not limited thereto. In other embodiments, a plurality of graphene-containing resin layers may be disposed in the hollow carbon fiber tube, and these graphene-containing resin layers may be the same or different from each other. The design of these hollow carbon fiber tube will be described below, but the present disclosure is not limited to these embodiments.

FIGS. 3 to 8 are schematic cross-sectional views of hollow carbon fiber tubes of different embodiments of the present disclosure.

In FIG. 3, the hollow carbon fiber tube 20 includes seven carbon fiber prepreg layers 102 and two graphene-containing resin layers 104. In the hollow carbon fiber tube 20, one graphene-containing resin layer 104 is disposed between the two outermost carbon fiber prepreg layers 102, and the other graphene-containing resin layer 104 is disposed between the second carbon fiber prepreg layer 102 and the third carbon fiber prepreg layer 102 from the outside to the inside. In addition, based on the above Formula (1), it may be calculated that the graphene location index L of the hollow carbon fiber tube 20 is greater than 0, so the hollow carbon fiber tube 20 may be regarded as having an outer-layer graphene design.

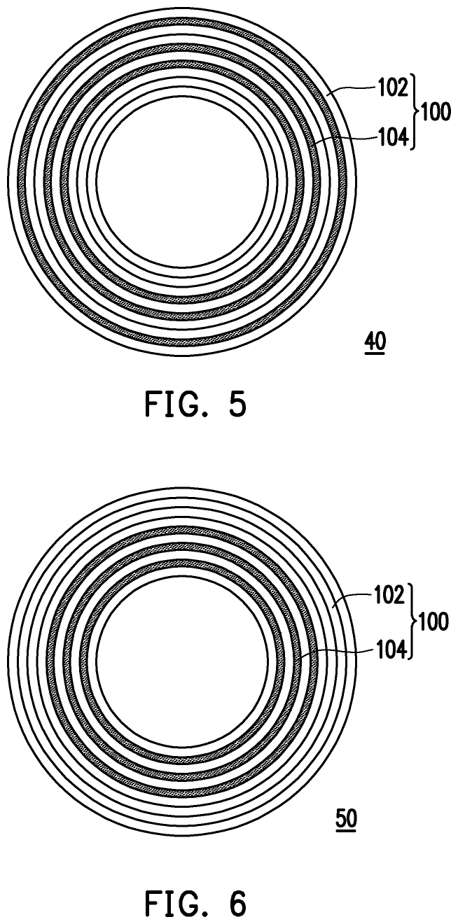

In the hollow carbon fiber tube 30 of FIG. 4, the difference from FIG. 3 is that one graphene-containing resin layer 104 is disposed between the two innermost carbon fiber prepreg layers 102, and the other graphene-containing resin layer 104 is disposed between the second carbon fiber prepreg layer 102 and the third carbon fiber prepreg layer 102 from the inside to the outside. Based on the above Formula (1), it may be calculated that the graphene location index L of the hollow carbon fiber tube 30 is less than 0, so the hollow carbon fiber tube 30 may be regarded as having an inner-layer graphene design.

In the hollow carbon fiber tube 40 of FIG. 5, the difference from FIG. 3 is that the hollow carbon fiber tube 40 includes seven carbon fiber prepreg layers 102 and three graphene-containing resin layers 104. In the hollow carbon fiber tube 40, a graphene-containing resin layer 104 is disposed between the two outermost carbon fiber prepreg layers 102, a graphene-containing resin layer 104 is disposed at the center portion of the composite material body 100, and a graphene-containing resin layer 104 is disposed between the center portion and the inner surface of the hollow carbon fiber tube 40. Based on the above Formula (1), it may be calculated that the graphene location index L of the hollow carbon fiber tube 40 is greater than 0, so the hollow carbon fiber tube 40 may be regarded as having an outer-layer graphene design.

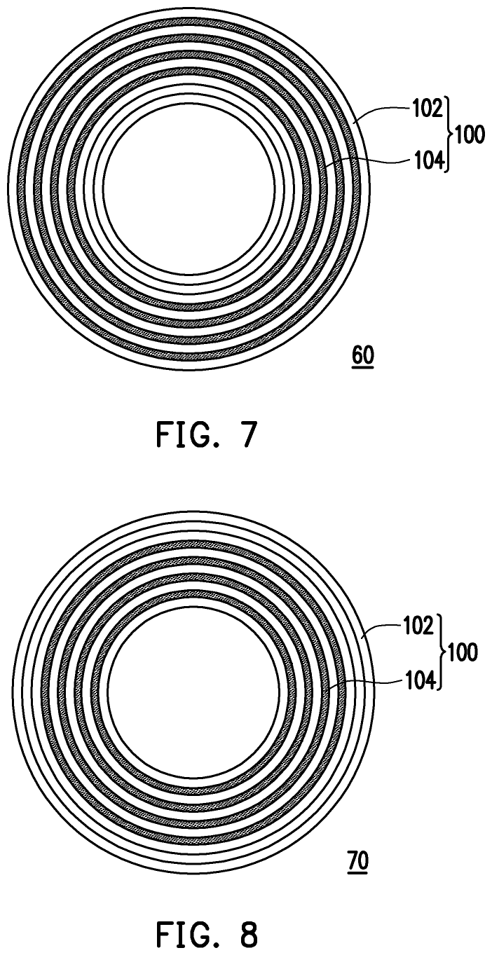

In the hollow carbon fiber tube 50 of FIG. 6, the difference from FIG. 5 is that a graphene-containing resin layer 104 is disposed at the center portion of the composite material body 100, and two graphene-containing resin layers 104 are disposed between the center portion and the inner surface of hollow carbon fiber tube 50. Based on the above Formula (1), it may be calculated that the graphene location index L of the hollow carbon fiber tube 50 is less than 0, so the hollow carbon fiber tube 50 may be regarded as having an inner-layer graphene design.

In the hollow carbon fiber tube 60 of FIG. 7, the difference from FIG. 3 is that the hollow carbon fiber tube 40 includes seven carbon fiber prepreg layers 102 and four graphene-containing resin layers 104. In the hollow carbon fiber tube 60, two graphene-containing resin layers 104 are disposed between the center portion of the composite material body 100 and the outer surface of the hollow carbon fiber tube 60, and two graphene-containing resin layers 104 are disposed between the center portion of the composite material body 100 and the inner surface of the hollow carbon fiber tube 60 and adjacent to the center portion. Based on the above Formula (1), it may be calculated that the graphene location index L of the hollow carbon fiber tube 60 is greater than 0, so the hollow carbon fiber tube 60 may be regarded as having an outer-layer graphene design.

In the hollow carbon fiber tube 70 of FIG. 8, the difference from FIG. 7 is that two graphene-containing resin layers 104 are disposed between the center portion of the composite material body 100 and the outer surface of the hollow carbon fiber tube 70 and adjacent to the center portion, and two graphene-containing resin layers 104 are disposed between the center portion and the inner surface of the hollow carbon fiber tube 70. Based on the above Formula (1), it may be calculated that the graphene location index L of the hollow carbon fiber tube 70 is less than 0, so the hollow carbon fiber tube 70 may be regarded as having an inner-layer graphene design.

In the following, experimental examples and comparative examples are used to conduct simulation tests to illustrate the torsional vibration suppression effect of the hollow carbon fiber tube of the embodiment of the present disclosure.

Test Method

ANSYS Enterprise 19.0 version is used for simulation test to simulate the displacement and time course of vibration and energy attenuation of an object. The preliminary boundary conditions of the simulation are that the bottom of the model is fixed in X, Y, and Z directions so that it cannot be moved, and a rotation angle of 1 degree in the X axis direction is applied to the top. After the preliminary boundary conditions are applied, release the aforementioned X-axis rotation angle and make it vibrate freely, record the rotation angle and time course, and analyze the results. Table 1, Table 2, Table 3 and Table 4 respectively show the results of the simulation test on the hollow carbon fiber tube of the experimental examples and the comparative examples with different configurations.

### Experimental Example

The hollow carbon fiber tube is formed by winding a composite material body including seven carbon fiber prepreg layers and different numbers of graphene-containing resin layers (torsional vibration suppression layers).

Different numbers of graphene-containing resin layers with a thickness of 0.075 mm were pasted between seven carbon fiber prepreg layers with a thickness of 0.125 mm to form a composite material body. The surface of the used graphene was modified and grafted to have an amine group (—NH₂), and based on the total weight of the graphene-containing resin layer, the content of graphene used is 2 wt %. Then, the composite material body was wound on a mandrel covered with a suitable plastic air bag, and placed in an aluminum metal mold and fixed. Then, the mandrel was withdrawn, and a pressure of 20 psi to 25 psi was applied to the aluminum metal mold. At this time, the plastic air bag was filled with gas with a pressure of 25 psi to 30 psi to prevent the internal structure from collapsing. Next, the aluminum mold was heated at a temperature of 160° C. After heating for 40 minutes, the temperature was naturally returned to room temperature to harden and shape. The formed composite material body was taken out from the aluminum metal mold, and the plastic air bag was pulled out. Afterwards, the surface modification and cutting were performed to make hollow carbon fiber tube.

### Comparative Example A

The hollow carbon fiber tube was manufactured in the same way as the experimental example, except that the hollow carbon fiber tube only includes seven carbon fiber prepreg layers.

### Comparative Example B

The hollow carbon fiber tube was manufactured in the same way as the experimental example, except that the hollow carbon fiber tube includes seven carbon fiber prepreg layers and different numbers of carbon nanotube-containing resin layers (torsional vibration suppression layers).

TABLE 1

| | | the thickness | | | | |
|---|---|---|---|---|---|---|
| | | ratio of the | | | | |
| | | torsional | | | | torsional |
| | the number | vibration | | | | vibration |
| | of torsional | suppression | the content of | | | suppression |
| | vibration | layer to the | graphene or | location | | ability |
| | suppression | composite | carbon | index | damping | improvement |
| | layers | material body | nanotube | L | ratio | rate |
| comparative | 0 | — | 0 | — | 0.060 | — |
| example A | | | | | | |
| comparative | 1 | 1:12.66 | 2 wt % | 0.3125 | 0.380 | 533% |
| example B1 | | | | | | |
| (structure in | | | | | | |
| FIG. 2) | | | | | | |
| experimental | 1 | 1:12.66 | 2 wt % | 0.3125 | 0.403 | 572% |
| example 1 | | | | | | |
| (structure as | | | | | | |
| FIG. 2) | | | | | | |
| experimental | 1 | 1:12.66 | 2 wt % | 0.0625 | 0.392 | 553% |
| example 2 | | | | | | |
| experimental | 1 | 1:12.66 | 2 wt % | −0.3125 | 0.385 | 542% |
| example 3 | | | | | | |

It may be seen from Table 1 that compared with the comparative example A without a torsional vibration suppression layer, the hollow carbon fiber tubes of experimental examples 1, 2 and 3 with the graphene-containing resin layer (torsional vibration suppression layer) may have a higher damping ratio, and therefore the torsional vibration suppression ability may be greatly improved. In addition, compared with the comparative example B1 with the carbon nanotube resin layer as the torsional vibration suppression layer, the hollow carbon fiber tube of the experimental example 1 with the same configuration, i.e., the same location index, may have a higher damping ratio and torsional vibration suppression ability. Compared with comparative example B 1, experimental examples 2 and 3 may have higher damping ratio and torsional vibration suppression ability. In addition, it may be seen from experimental examples 1, 2 and 3 that when the hollow carbon fiber tube has an outer-layer graphene design, the damping ratio and torsional vibration suppression ability may be further improved.

TABLE 2

| | | the thickness | | | | |
|---|---|---|---|---|---|---|
| | | ratio of the | | | | |
| | | torsional | | | | torsional |
| | the number | vibration | | | | vibration |
| | of torsional | suppression | the content of | | | suppression |
| | vibration | layer to the | graphene or | location | | ability |
| | suppression | composite | carbon | index | damping | improvement |
| | layers | material body | nanotube | L | ratio | rate |
| comparative | 0 | — | 0 | — | 0.060 | — |
| example A | | | | | | |
| comparative | 2 | 1:6.83 | 2 wt % | 0.25 | 0.388 | 547% |
| example B2 | | | | | | |
| (structure as | | | | | | |
| FIG. 3) | | | | | | |
| experimental | 2 | 1:6.83 | 2 wt % | 0.25 | 0.428 | 613% |
| example 4 | | | | | | |
| (structure as | | | | | | |
| FIG. 3) | | | | | | |
| experimental | 2 | 1:6.83 | 2 wt % | −0.25 | 0.400 | 567% |
| example 5 | | | | | | |
| (structure as | | | | | | |
| FIG. 4) | | | | | | |

It may be seen from Table 2 that the hollow carbon fiber tubes of experimental examples 4 and 5 with the graphene-containing resin layer (torsional vibration suppression layer) may have a higher damping ratio compared with the comparative example A without torsional vibration suppression layer, and thus the torsional vibration suppression ability may be greatly improved. In addition, compared with the comparative example B2 with the carbon nanotube resin layer as the torsional vibration suppression layer, the hollow carbon fiber tube of the experimental example 4 with the same configuration, i.e., the same location index, may have a higher damping ratio and torsional vibration suppression ability. Compared with comparative example B2, experimental example 5 may have higher damping ratio and torsional vibration suppression ability. In addition, it may be seen from experimental examples 4 and 5 that when the hollow carbon fiber tube has an outer-layer graphene design, the damping ratio and torsional vibration suppression ability may be further improved.

TABLE 3

| | | the thickness | | | | |
|---|---|---|---|---|---|---|
| | | ratio of the | | | | |
| | | torsional | | | | torsional |
| | the number | vibration | | | | vibration |
| | of torsional | suppression | the content of | | | suppression |
| | vibration | layer to the | graphene or | location | | ability |
| | suppression | composite | carbon | index | damping | improvement |
| | layers | material body | nanotube | L | ratio | rate |
| comparative | 0 | — | 0 | — | 0.060 | — |
| example A | | | | | | |
| comparative | 3 | 1:4.88 | 2 wt % | 0.1875 | 0.395 | 558% |
| example B3 | | | | | | |
| experimental | 3 | 1:4.88 | 2 wt % | 0.1042 | 0.455 | 658% |
| example 6 | | | | | | |
| (structure as | | | | | | |
| FIG. 5) | | | | | | |
| experimental | 3 | 1:4.88 | 2 wt % | −0.1875 | 0.400 | 567% |
| example 7 | | | | | | |
| (structure as | | | | | | |
| FIG. 6) | | | | | | |

It may be seen from Table 3 that the hollow carbon fiber tubes of experimental examples 6 and 7 with graphene-containing resin layer (torsional vibration suppression layer) may have a higher damping ratio compared with the comparative example A without torsional vibration suppression layer, and thus the torsional vibration suppression ability may be greatly improved. In addition, compared with the comparative example B3 with the carbon nanotube resin layer as the torsional vibration suppression layer, the hollow carbon fiber tubes of experimental examples 6 and 7 may have higher damping ratio and torsional vibration suppression ability. In addition, it may be seen from experimental examples 6 and 7 that when the hollow carbon fiber tube has an outer-layer graphene design, the damping ratio and torsional vibration suppression ability may be further improved.

TABLE 4

| | | the thickness | | | | |
|---|---|---|---|---|---|---|
| | | ratio of the | | | | |
| | | torsional | | | | torsional |
| | the number | vibration | | | | vibration |
| | of torsional | suppression | the content of | | | suppression |
| | vibration | layer to the | graphene or | location | | ability |
| | suppression | composite | carbon | index | damping | improvement |
| | layers | material body | nanotube | L | ratio | rate |
| comparative | 0 | — | 0 | — | 0.060 | — |
| example A | | | | | | |
| comparative | 4 | 1:3.91 | 2 wt % | 0.125 | 0.408 | 580% |
| example B4 | | | | | | |
| (structure as | | | | | | |
| FIG. 7) | | | | | | |
| experimental | 4 | 1:3.91 | 2 wt % | 0.125 | 0.458 | 663% |
| example 8 | | | | | | |
| (structure as | | | | | | |
| FIG. 7) | | | | | | |
| experimental | 4 | 1:3.91 | 2 wt % | −0.125 | 0.428 | 613% |
| example 9 | | | | | | |
| (structure as | | | | | | |
| FIG. 8) | | | | | | |

It may be seen from Table 4 that the hollow carbon fiber tubes of experimental examples 8 and 9 with graphene-containing resin layer (torsional vibration suppression layer) may have a higher damping ratio compared with the comparative example A without torsional vibration suppression layer, and thus the torsional vibration suppression ability may be greatly improved. In addition, compared with the comparative example B4 with the carbon nanotube resin layer as the torsional vibration suppression layer, the hollow carbon fiber tube of the experimental example 8 with the same configuration, i.e., the same location index, may have a higher damping ratio and torsional vibration suppression ability. Compared with the comparative example B4, the experimental example 9 may have a higher damping ratio and torsional vibration suppression ability. In addition, it may be seen from experimental examples 8 and 9 that when the hollow carbon fiber tube has an outer-layer graphene design, the damping ratio and torsional vibration suppression ability may be further improved.

It will be apparent to those skilled in the art that various modifications and variations may be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hollow carbon fiber tube, formed by winding a composite material body, the composite material body comprising:
a plurality of carbon fiber prepreg layers; and
at least one graphene-containing resin layer,
wherein each of the at least one graphene-containing resin layer is disposed between two adjacent carbon fiber prepreg layers, and the total thickness of the at least one graphene-containing resin layer is 1/15 to ⅓ of the thickness of the composite material body.

2. The hollow carbon fiber tube of claim 1, wherein the at least one graphene-containing resin layer comprises a first graphene-containing resin layer, and the first graphene-containing resin layer is adjacent to the outer surface of the hollow carbon fiber tube.

3. The hollow carbon fiber tube of claim 2, wherein the at least one graphene-containing resin layer further comprises a second graphene-containing resin layer, and the second graphene-containing resin layer is disposed between two adjacent carbon fiber prepreg layers and far away from the outer surface of the hollow carbon fiber.

4. The hollow carbon fiber tube of claim 1, wherein each of the plurality of carbon fiber prepreg layers comprises a resin material and a carbon fiber layer impregnated with the resin material.

5. The hollow carbon fiber tube of claim 4, wherein the resin material is a thermoplastic material or a thermosetting material.

6. The hollow carbon fiber tube of claim 1, wherein the graphene-containing resin layer comprises a resin material and graphene contained in the resin material.

7. The hollow carbon fiber tube of claim 6, wherein the resin material is a thermoplastic material or a thermosetting material.

8. The hollow carbon fiber tube of claim 6, wherein the specific surface area of the graphene is 30 m²/g to 500 m²/g.

9. The hollow carbon fiber tube of claim 6, wherein the content of the graphene is 0.5 wt % to 5 wt %.

10. The hollow carbon fiber tube of claim 6, wherein the graphene has a reactive functional group on the surface thereof, and the reactive functional group comprises an amino group, a carboxyl group, a hydroxyl group, an acyl chloride group or a combination thereof.

11. The hollow carbon fiber tube of claim 1, wherein the thickness of each of the plurality of carbon fiber prepreg layers is 50 μm to 200 μm.

12. The hollow carbon fiber tube of claim 1, wherein the thickness of each of the at least one graphene-containing resin layer is 5 μm to 200 μm.

13. The hollow carbon fiber tube of claim 1, wherein a graphene location index (L) of the hollow carbon fiber tube calculated according to Formula (1) is greater than 0,
$$L = \frac{d ( 1 ) + d ( 2 ) + … + d ( n )}{n} \qquad Formula ( 1 )$$
wherein n is the number of graphene-containing resin layers in the composite material body, and d(i) is the distance from the i-th graphene-containing resin layer to the center of the hollow carbon fiber tube in the thickness direction of the composite material body.
